(19) United States
(12) Patent Application Publication
(10) Pub. No.: US 2013/0323693 A1
(43) Pub. Date: Dec. 5, 2013

(54) PROVIDING AN UNINTERRUPTED READING EXPERIENCE

(71) Applicants: ANKUR GANDHE, BANGALORE (IN); RASHMI GANGADHARAIAH, BANGALORE (IN); ANANTHAKRISHNAN RAMANATHAN, BANGALORE (IN); KARTHIK VISWESWARIAH, BANGALORE (IN)

(72) Inventors: ANKUR GANDHE, BANGALORE (IN); RASHMI GANGADHARAIAH, BANGALORE (IN); ANANTHAKRISHNAN RAMANATHAN, BANGALORE (IN); KARTHIK VISWESWARIAH, BANGALORE (IN)

(73) Assignee: INTERNATIONAL BUSINESS MACHINES CORPORATION, ARMONK, NY (US)

(21) Appl. No.: 13/484,910

(22) Filed: May 31, 2012

(51) Int. Cl. G09B 17/00

(52) U.S. Cl. 434/178

(57) ABSTRACT

An uninterrupted reading experience can be provided by calculating a vocabulary level for a user in a first language and comparing difficulty levels of words within a document in the first language to the vocabulary level of the user in the first language. Each word of the document having a difficulty level that exceeds the vocabulary level of the user in the first language can be selected.

### BACKGROUND

A reader's ability to comprehend a document is largely dependent upon the size of the vocabulary possessed by the individual. Without possession of an adequately sized vocabulary, the reader is forced to pause frequently while reading to look-up the meaning of unknown words. In order to achieve adequate reading comprehension, the reader typically must understand upwards of 98% of the words within the text being read. The size of vocabulary required to reach the 98% understanding threshold can range from approximately five thousand words to approximately fifteen thousand words.

### BRIEF SUMMARY

One or more embodiments disclosed within this specification relate to providing an uninterrupted reading experience to a user.

An embodiment can include a method. The method can include calculating a vocabulary level for a user in a first language and comparing, using a processor, difficulty levels of words within a document in the first language to the vocabulary level of the user in the first language. The method further can include selecting each word of the document having a difficulty level that exceeds the vocabulary level of the user in the first language.

Another embodiment can include a method. The method can include calculating a vocabulary level for a first user in a first language, determining a difficulty level for each of a plurality of words within a document in the first language, and comparing, using a processor, the difficulty level of words in the document to the vocabulary level of the first user. The method further can include selecting each word having a difficulty level that exceeds the vocabulary level of the first user for the first language.

Another embodiment can include a system. The system can include a processor configured to initiate executable operations. The executable operations can include calculating a vocabulary level for a user in a first language and comparing difficulty levels of words within a document in the first language to the vocabulary level of the user in the first language. The executable operations also can include selecting each word of the document having a difficulty level that exceeds the vocabulary level of the user in the first language.

Another embodiment can include a system. The system can include a processor configured to initiate executable operations. The executable operations can include calculating a vocabulary level for a first user in a first language, determining a difficulty level for each of a plurality of words within a document in the first language, and comparing the difficulty level of words in the document to the vocabulary level of the first user. The executable operations can include selecting each word having a difficulty level that exceeds the vocabulary level of the first user for the first language.

Another embodiment can include a computer program product. The computer program product can include a computer readable storage medium having computer readable program code embodied therewith that, when executed, configures a processor to perform executable operations. The executable operations can include calculating a vocabulary level for a user in a first language, comparing difficulty levels of words within a document in the first language to the vocabulary level of the user in the first language, and selecting each word of the document having a difficulty level that exceeds the vocabulary level of the user in the first language.

### BRIEF DESCRIPTION OF THE SEVERAL VIEWS OF THE DRAWINGS

FIG. 1 is a block diagram illustrating a data processing system in accordance with one embodiment disclosed within this specification.

FIG. 2 is a block diagram illustrating a readability module as illustrated in FIG. 1 in accordance with another embodiment disclosed within this specification.

FIG. 3 is a flow chart illustrating a method of calculating a vocabulary level of a user in accordance with another embodiment disclosed within this specification.

FIG. 4 is a flow chart illustrating a method of improving readability of a document in accordance with another embodiment disclosed within this specification.

FIG. 5 is a view generated by the readability module of FIG. 1 in accordance with another embodiment disclosed within this specification.

FIG. 6 is a view generated by the readability module of FIG. 1 in accordance with another embodiment disclosed within this specification.

FIG. 7 is a view generated by the readability module of FIG. 1 in accordance with another embodiment disclosed within this specification.

FIG. 8 is a view generated by the readability module of FIG. 1 in accordance with another embodiment disclosed within this specification.

FIG. 9 is a view generated by the readability module of FIG. 1 in accordance with another embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more embodiments disclosed within this specification relate to providing an uninterrupted reading experience to a user. In accordance with the inventive arrangements disclosed within this specification, a vocabulary level for a user can be determined. A document, e.g., text, that is to be read by the user can be evaluated to determine the readability of the various words included therein. For example, difficulty levels for words within the document can be determined. Words within the document that have a difficulty level exceeding the vocabulary level of the user can be identified. One or more processing techniques can be applied to the identified words to improve readability of the document for the user.

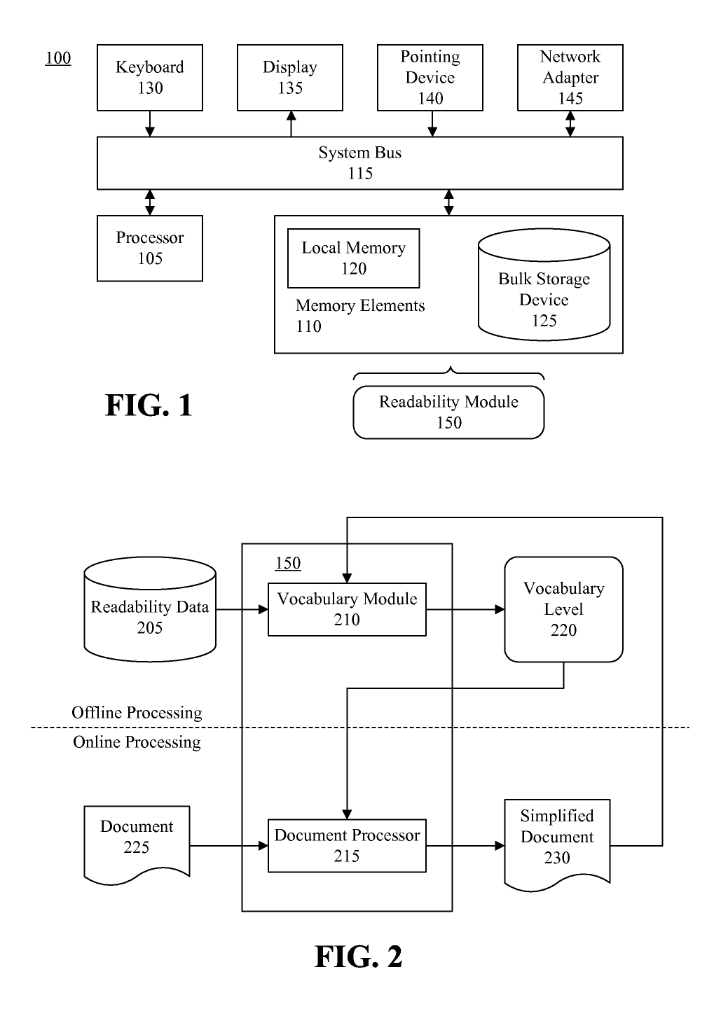

FIG. 1 is a block diagram illustrating a data processing system (system) 100 in accordance with one embodiment disclosed within this specification. System 100 can include at least one processor 105 coupled to memory elements 110 through a system bus 115 or other suitable circuitry. As such, system 100 can store program code within memory elements 110. Processor 105 can execute the program code accessed from memory elements 110 via system bus 115. In one aspect, for example, system 100 can be implemented as a computer that is suitable for storing and/or executing program code. It should be appreciated, however, that system 100 can be implemented in the form of any system including a processor and memory that is capable of performing the functions and/or operations described within this specification.

Memory elements 110 can include one or more physical memory devices such as, for example, local memory 120 and one or more bulk storage devices 125. Local memory 120 refers to RAM or other non-persistent memory device(s) generally used during actual execution of the program code. Bulk storage device(s) 125 can be implemented as a hard disk drive (HDD), a solid state drive (SSD), or other persistent data storage device. System 100 also can include one or more cache memories (not shown) that provide temporary storage of at least some program code in order to reduce the number of times program code must be retrieved from bulk storage device 125 during execution.

Input/output (I/O) devices such as a keyboard 130, a display 135, and a pointing device 140 optionally can be coupled to system 100. The I/O devices can be coupled to system 100 either directly or through intervening I/O controllers. One or more network adapters 145 also can be coupled to system 100 to enable system 100 to become coupled to other systems, computer systems, remote printers, and/or remote storage devices through intervening private or public networks. Modems, cable modems, and Ethernet cards are examples of different types of network adapters 145 that can be used with system 100.

As pictured in FIG. 1, memory elements 110 can store a readability module 150. Readability module 150, being implemented in the form of executable program code, can be executed by system 100 and, as such, can be considered part of system 100. In one aspect, readability module 150 can be implemented as a standalone application that is configured to operate cooperatively with one or more other applications. In another aspect, readability module 150 can be implemented in the form of an extension or a plug-in that operates within, and therefore, cooperatively with, one or more other applications.

System 100, executing readability module 150, can perform functions including, but not limited to, paraphrasing documents based upon a user-specific vocabulary level that is determined. One or more words that are identified as exceeding the vocabulary level of the user within a document can be processed in a variety of different ways. In one aspect, words identified within a document that have a difficulty level exceeding the vocabulary level of the user can be visually distinguished from words having a difficulty level not exceeding the vocabulary level of the user. A paraphrased version of the identified words can be provided or used to replace the identified words within the document. The paraphrased version of a word, or phrase as the case may be, can be in a same language as the identified word or in a different language than the identified word.

In general, a paraphrased version of a word (or phrase) is a restatement of the subject text, passage, or work giving the meaning, e.g., the same or similar meaning as the original word or phrase being paraphrased, in another form. The paraphrased version, for example, can be a definition of the word or phrase being paraphrased, a synonym, etc. In one aspect, the paraphrased version can be in a different language than the word or phrase being paraphrased. In this regard, a paraphrased version of a word or phrase can be a translation.

FIG. 2 is a block diagram illustrating the readability module 150 of FIG. 1 in accordance with another embodiment disclosed within this specification. As shown, readability module 150 can include a vocabulary module 210 and a document processor 215. In general, FIG. 2 illustrates an offline processing phase that can be implemented by vocabulary module 210 and an online processing phase that can be implemented by document processor 215.

Vocabulary module 210 can evaluate readability data 205 and calculate a vocabulary level 220 that is specific to a particular user and that is specific for a language understood by the user. Readability data 205 can include a variety of different types of data drawn from various sources and can be evaluated collectively to determine vocabulary level 220. In one aspect, readability data can include user-specific data, global user data, and language-specific data.

User-specific data can be used to indicate words that a particular user has difficulty in reading. As used within this specification, the term “words” refers to more than one word. In one aspect, the term “words” can refer to two or more sequential words as in the case of a phrase. In another aspect, the term “words” can refer to non-sequential individual words as in the case of one or more words that are separated by one or more other intervening words or symbols. It should be appreciated that while operation of the one or more embodiments disclosed within this specification is described largely with reference to a word by word type of evaluation, a phrase level evaluation of text can be performed so that phrases (e.g., two or more consecutive words and/or symbols) can be determined to have a particular difficulty level as a group, e.g., at the phrase level. Accordingly, reference to a word or words within this specification can include the processing of a phrase or phrases.

In one aspect, user-specific data can include a reading history for the user and/or a writing history for the user. The reading history can include various electronic documents that the user has received or read including, but not limited to, electronic mails, blogs, articles, word processing documents, other text documents, Web pages, or the like. In general, the reading history of the user includes electronic documents that include text that is not authored by the user.

The writing history of the user can include various electronic documents that the user has originated or written including, but not limited to, electronic mail, blogs, articles, word processing documents, other text documents, Web pages, or the like. In general, the writing history of the user includes electronic documents that include text that has been authored by the user. It should be appreciated that the reading history and/or writing history for the user should be specified in a single or same language.

In one aspect, vocabulary module 210 can determine a difficulty level for words within the reading history and/or writing history for the user according to the frequency with which each respective word appears in the data being evaluated, i.e., the reading and/or writing history for the user. For example, the higher the frequency of appearance of a word within the corpus of text formed of the reading and/or writing history of the user, the lower the difficulty level assigned to the word.

Global user data can include a corpus of text that is collected from a plurality of different users. The users from which the text is collected, however, can have one or more attributes that are like or match. While the term “match” or “matching” can refer to exact matches, in another example, a match can be considered to exist when one parameter is within a predetermined range of another parameter, e.g., either above or below. In this regard, the users from which text is collected, e.g., the reading and/or writing histories of the users, can be considered related or part of a same group as defined by the matching attributes of the various user members. For example, given a group of one or more users with similar or same attributes such as age, gender, level of education, geographic location, etc., reading histories and/or writing histories can be collected to form a corpus of text. The corpus of text that is collected can be in the same language as the user-specific data. Vocabulary module 210 can determine a difficulty level for each word within the corpus of text according to frequency of appearance of each respective word in the corpus of text as described.

Language-specific data can include a corpus of text for a particular language, i.e., the same language in which the user-specific data and the global user data is specified. The corpus of text can include text sources (e.g., reading and/or writing histories) from a plurality of different users, or persons, and can be a varied in terms of the sample or group of users used. Whereas the global user data reflects readability for users with like attributes, the language-specific data reflects readability of a particular language in general and is generated from users with varied attributes across a plurality of disparate user groups as defined by the attributes and types of texts that are collected to form the corpus used. Vocabulary module 210 can determine a difficulty level of each word within the corpus of text. In one aspect, the difficulty level can be determined according to frequency of appearance of each respective word within the corpus.

In any case, vocabulary module 210 can process the readability data and generate vocabulary level 220 for the user. Vocabulary module 210, for example, can generate vocabulary level 220 as a function of the user-specific data, the global user data, and the language-specific data. Accordingly, vocabulary level 220 is user-specific and is language-specific. In the event that the user understands a second and different language, a further vocabulary level for the second language can be calculated. It should be appreciated that the readability data used will be specific for the second language.

The offline processing can take place prior to any processing of a document for purposes of readability. Processing a document for readability in accordance with vocabulary level 220 of the user takes place during online processing. As shown, document processor 215 can receive a document 225 and vocabulary level 220 as input. Document processor 215 can perform any of a variety of different operations including, for example, generating a simplified version of document 225 shown as simplified document 230 in FIG. 2. Other operations can include paraphrasing one or more words of the document. As noted, the paraphrased versions of the words can be in the same or in a different language.

Frequency of appearance of a word is provided as one example of a way to determine difficulty levels of words. The one or more embodiments disclosed within this specification can utilize any of a variety of methods, statistical or otherwise, for determining a difficulty level of a word and are not intended to be limited to the examples provided.

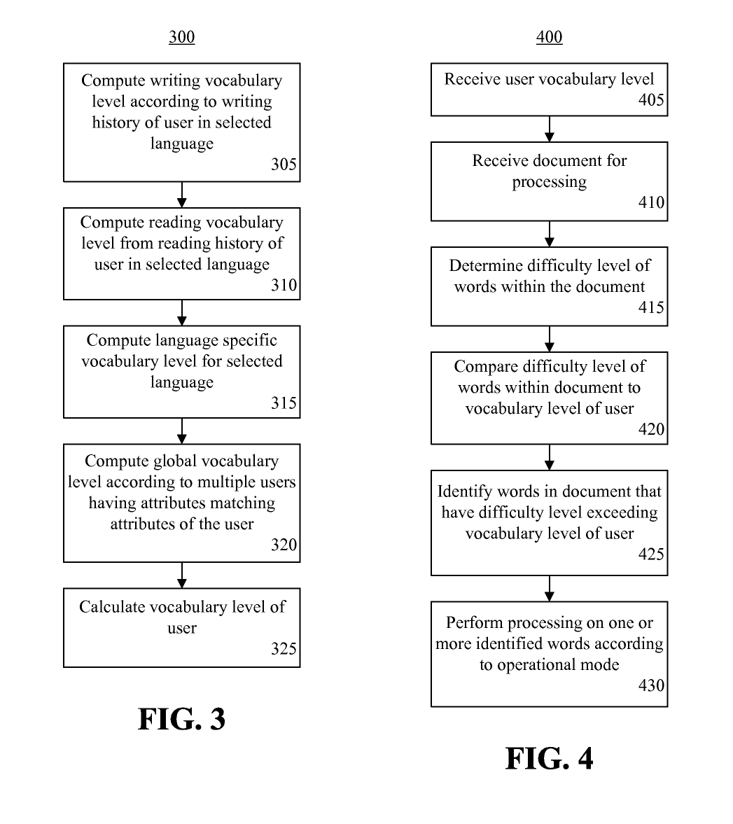

FIG. 3 is a flow chart illustrating a method 300 of calculating a vocabulary level of a user in accordance with another embodiment disclosed within this specification. Method 300 illustrates an offline process in which the vocabulary level of a specific user for a specific, e.g., a first or selected, language is determined. Method 300 can be performed by the system described with reference to FIGS. 1-2 of this specification. For example, method 300 can be performed using vocabulary module 210 of FIG. 1.

Accordingly, in step 305, the system can compute a writing vocabulary level for the user according to the writing history of the user in the selected language. For example, the system can determine the writing vocabulary level according to an average, or weighted average, of the difficulty levels of the words observed in the writing history of the user. In step 310, the system can compute a reading vocabulary level from the reading history of the user in the selected language. For example, the system can determine an average, or a weighted average, of the difficulty levels of the words observed in the reading history of the user.

In step 315, the system can compute a language-specific vocabulary level for the selected language. The system, for example, can determine an average, or a weighted average, of the difficulty levels of the words located in the language-specific data, e.g., the language-specific corpus of text. In step 320, the system can compute a global vocabulary level according to multiple users having attributes matching the attributes of the user. For example, the system can determine an average, or weighted average, of the difficulty levels of words found within the corpus of text of the global user data.

In step 325, the system can calculate the vocabulary level of the user for the selected language. The vocabulary level can be calculated as a function of the writing vocabulary level, the reading vocabulary level, the language-specific vocabulary level, and the global vocabulary level.

For example, the vocabulary level of the user can be calculated according to expression 1 below.

VLᵤₛₑᵣ=[a(VL_{writing})+b(VL_{reading})][c(VL_{global})+d(VL_{language})] (1)

Within expression 1, VLᵤₛₑᵣ refers to the vocabulary level of the user, VL_{writing} refers to the writing vocabulary level, VL_{reading} refers to the reading vocabulary level, VL_{global} refers to the global vocabulary level, and VL_{language} refers to the language-specific vocabulary level. The terms “a” and “b” can be constants that can be used to weight VL_{writing} and VL_{reading} independently of one another. The terms “a” and “b” can be set equal to one another or can be different values to increase or decrease the relative importance of the writing vocabulary level and/or the reading vocabulary level as deemed appropriate. The terms “c” and “d” can be constants that can be used to weight VL_{global} and VL_{language} respectively. The terms “c” and “d” can be set equal to one another or can be different values to increase or decrease the relative importance of the global vocabulary level and/or the language-specific vocabulary level as deemed appropriate. Within expression 1, the quantity [c(VL_{global})+d(VL_{language})] can be used to adjust the user-specific vocabulary quantities according to the peer group to which the user belongs and/or the general difficulty of the language being used.

In another example, the vocabulary level of a user can be calculated according to expression (2) below.

VLᵤₛₑᵣ=a*log(VL_{writing})+b*log(VL_{reading})+c*log(VL_{global})+d*log(VL_{language})] (2)

It should be appreciated that method 300 is provided for purposes of illustration only. The particular examples provided within this specification are not intended as limitations. Rather, one or more other techniques and/or functions can be used to calculate the vocabulary level of a user. Such techniques and/or functions can include the quantities described herein, fewer than all of the quantities described herein, additional quantities, or different quantities. Further, as noted, FIG. 3 illustrates an exemplary process for calculating the vocabulary level of a user in a particular language. Further vocabulary levels for the user in different languages can be determined by generally repeating method 300 using data sources for different languages as described.

FIG. 4 is a flow chart illustrating a method 400 of improving readability of a document in accordance with another embodiment disclosed within this specification. Method 400 illustrates an online process in which readability of a document is improved for the user. Method 400 can be performed by the system described with reference to FIGS. 1-3 of this specification. For example, method 400 can be performed by document processor 215 of FIG. 1.

Accordingly, in step 405, the system can receive a vocabulary level for a user. As noted, the vocabulary level for the user is specific to the user and is language-specific, e.g., is for a first language. In step 410, the system can receive a document for processing. The document received for processing can be one that includes text. Examples of the document can include, but are not limited to, Web pages, word processing documents, electronic mails, or the like. In one aspect, the document processor of FIG. 1 can be executing within, or cooperatively with, the particular application program responsible for rendering, e.g., displaying, the document being processed.

In step 415, the system can determine the difficulty level of words within the document. In one aspect, the system can determine the difficulty level of words in the document as from the global user data, the language-specific data, or a combination of both. For example, the document processor can determine the difficulty level of each word in the document to be the difficulty level of the word as specified directly within the global user data, the language-specific data, or by taking an average or a weighted average of the difficulty level of the word from each of the global user data and the language-specific data.

In step 420, the system can compare the difficulty level of the words within the document to the vocabulary level of the user. For example, the system can compare the difficulty level of each word within the document to the vocabulary level of the user. In step 425, the system can identify, or select, the words in the document that have a difficulty level exceeding the vocabulary level of the user. In step 430, the system can perform processing on one or more words identified in step 425 in accordance with an operational mode of the system in effect at the time. In one aspect, the particular words upon which the system operates can be limited to those words identified in step 425, i.e., any of the words having a difficulty level exceeding the vocabulary level of the user that is also selected by the user.

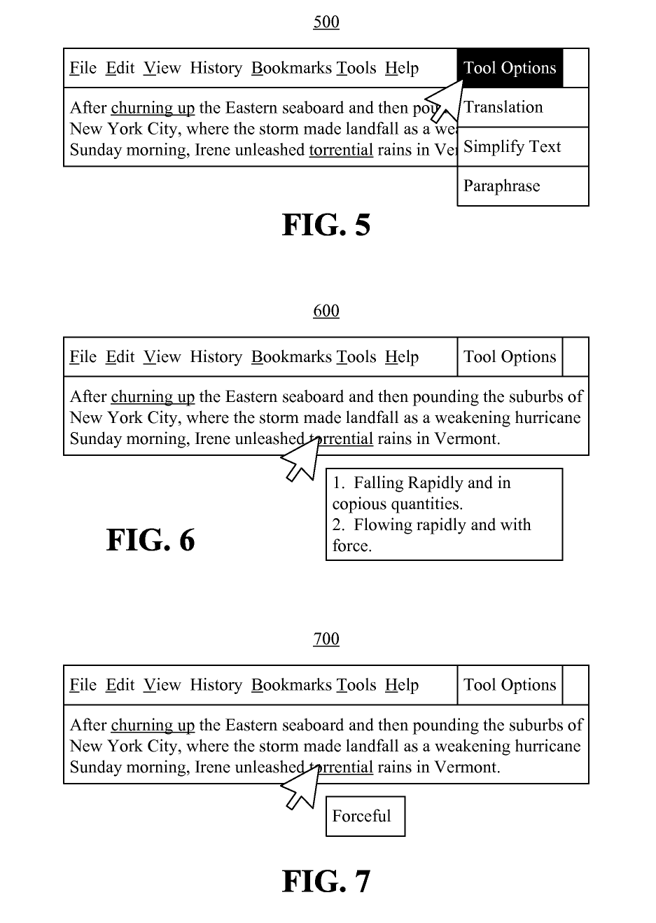

FIG. 5 is a view 500 generated by readability module 150 of FIG. 1 in accordance with another embodiment disclosed within this specification. As shown, a drop down menu labeled “Tool Options” is provided through which a user can select one of a plurality of different operational modes. Responsive to selecting “Tool Options,” the operational modes including, but not limited to, “Translation,” “Simplify Text,” and “Paraphrase” are shown.

Within FIG. 5, the text of a document is shown after processing as performed by the document processor. As illustrated, the phrase “churning up” and the word “torrential” are underlined within the document. In the example presented in FIG. 5, underlining is used to visually distinguish words, and also phrases, having a difficulty level for the language shown that exceeds the vocabulary level of the user for that same language. It should be appreciated that any of a variety of different techniques can be used to visually distinguish words such as highlighting, using different colors, or the like.

FIG. 6 is a view 600 generated by readability module 150 of FIG. 1 in accordance with another embodiment disclosed within this specification. FIG. 6 illustrates an example in which the user has selected the paraphrase operational mode. Accordingly, the system is configured to provide a paraphrased version of a word identified as having a difficulty level exceeding the vocabulary level of the user when selected by the user.

In the example shown, the user selects the word “torrential” using a pointer, e.g., by hovering over the underlined word. In response to the user selection of the word “torrential,” a tool tip or other pop-up type of interface element can be presented in which the paraphrased version of the selected word is displayed. In this example, the paraphrased version of the selected word is one or more definitions of the word, thereby allowing the user to determine the meaning of the word as the word exists in place within the document being read. Further, the paraphrased version of the word is in the same language as the word that is selected.

In one aspect, the availability of paraphrased versions of a word can be limited to only those words that are visually distinguished from other words in the document and, as such, have difficulty levels exceeding the vocabulary level of the user. In this manner, the system anticipates the particular words with which the user will have difficulty in understanding.

In another aspect, the paraphrased version of the word that is presented to the user can be limited to words having a difficulty level that is at or below, e.g., does not exceed, the vocabulary level of the user. Accordingly, a word or words with a lower vocabulary level than the selected word are presented as the paraphrased version for the selected word. Thus, the likelihood that the user is able to understand the paraphrased version displayed is increased.

FIG. 7 is a view 700 generated by readability module 150 of FIG. 1 in accordance with another embodiment disclosed within this specification. FIG. 7 illustrates another example in which the user has selected the paraphrase operational mode. Accordingly, the system is configured to provide a paraphrased version of a word identified as having a difficulty level exceeding the vocabulary level of the user when selected. In the example shown, the paraphrased version of the selected word is “forceful,” which is a synonym or word or phrase of similar if not the same meaning, as the selected word.

The paraphrased version of the word is in the same language as the word that was selected. As discussed, the difficulty level of the word or words presented as the paraphrased version can be limited to only those words having a difficulty level that is at or below, e.g., does not exceed, the vocabulary level of the user.

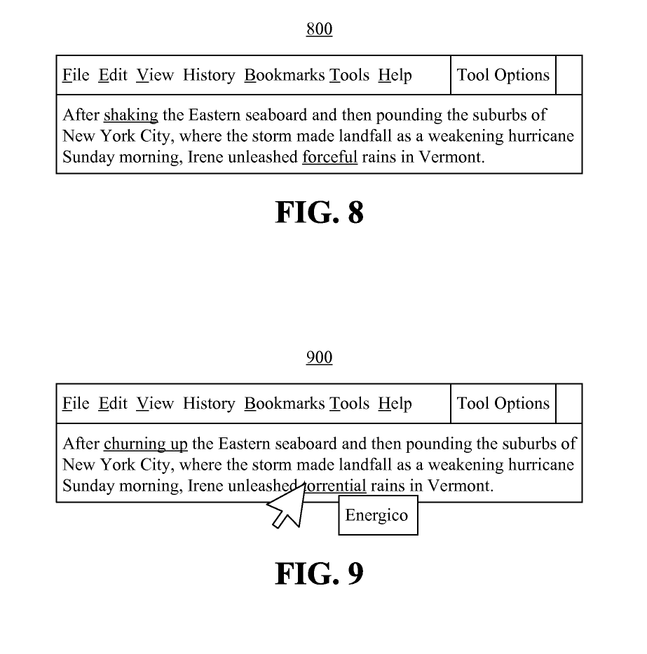

FIG. 8 is a view 800 generated by readability module 150 of FIG. 1 in accordance with another embodiment disclosed within this specification. FIG. 8 illustrates an example in which the user has selected the “Simplify Text” operational mode. As pictured, responsive to selecting the simplify text mode, the system has automatically replaced the underlined words with paraphrased versions of the underlined words. The paraphrased versions have a difficulty level that is at or below the vocabulary level of the user. The paraphrased versions are displayed in place of the underlined words so that the resulting text includes no words (or phrases) that have a difficulty level exceeding the vocabulary level of the user.

FIG. 9 is a view 900 generated by readability module 150 of FIG. 1 in accordance with another embodiment disclosed within this specification. FIG. 9 illustrates an example in which the user has selected the “Translate” operational mode. In using the translate operational mode, the user can be associated with a vocabulary level for a first language and a vocabulary level for a second and different language.

In the example illustrated in FIG. 9, the first language can be English. Those words having a difficulty level exceeding the vocabulary level of the user for English are underlined automatically by the system while displaying the document, or a portion of the document. As shown, the user has selected the underlined word “torrential.” Accordingly, the system presents a paraphrased version of the selected word in the second and different language, which is Italian in this case.

The example illustrated in FIG. 9 shows the paraphrased version being shown as a translation. It should be appreciated that the paraphrased version of the selected word can be a definition of the selected word albeit in the second language, a direct translation of the selected word, or a synonym or other word having a same or similar meaning as the selected word, but in the second language. In each case, the word(s) displayed as the paraphrased version of the selected word in the second language can have a level of difficulty in the second language that does not exceed the vocabulary level of the user in the second language.

For purposes of illustration, the paraphrased version of the selected word in the second language is shown within a pop-up type of user interface element. It should be appreciated, however, that the paraphrased version in the second language can be presented in place of the selected word, e.g., in-place within the document. Further, the user system can be configured to present a simplified text version of the document in which the underlined words are automatically replaced with paraphrased versions in the second language and having a difficulty level not exceeding the vocabulary level of the user in the second language.

The embodiments disclosed within this specification can account for the situation in which a user has a high level of proficiency in a second language (e.g., the native language of the user), but a lower level of proficiency in the first language (e.g., the language of the document being read).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

1-12. (canceled)

13. A system, comprising:
a processor configured to initiate executable operations comprising:
calculating a vocabulary level for a user in a first language;
comparing difficulty levels of words within a document in the first language to the vocabulary level of the user in the first language; and
selecting each word of the document having a difficulty level that exceeds the vocabulary level of the user in the first language.

14. The system of claim 13, wherein the processor is further configured to initiate an executable operation comprising:
visually distinguishing each selected word from non-selected words while displaying the document.

15. The system of claim 13, wherein the processor is further configured to initiate an executable operation comprising:
displaying a paraphrased version of a selected word, wherein the paraphrased version is in the first language and has a difficulty level not exceeding the vocabulary level of the user.

16. The system of claim 13, wherein the first user has a vocabulary level for a second and different language, and wherein the processor is further configured to initiate an executable operation comprising:
displaying a paraphrased version of a selected word, wherein the paraphrased version is in the second language and has a difficulty level in the second language not exceeding the vocabulary level of the user in the second language.

17. A system, comprising:
a processor configured to initiate executable operations comprising:
calculating a vocabulary level for a first user in a first language;
determining a difficulty level for each of a plurality of words within a document in the first language;
comparing the difficulty level of words in the document to the vocabulary level of the first user; and
selecting each word having a difficulty level that exceeds the vocabulary level of the first user for the first language.

18. The system of claim 17, wherein the processor is further configured to initiate an executable operation comprising:
visually distinguishing each selected word from non-selected words while displaying the document.

19. The system of claim 17, wherein the processor is further configured to initiate an executable operation comprising:
displaying a paraphrased version of a selected word, wherein the paraphrased version is in the first language and has a difficulty level not exceeding the vocabulary level of the first user.

20. The system of claim 17, wherein the processor is further configured to initiate an executable operation comprising:
displaying a paraphrased version of a selected word, wherein the paraphrased version is in the second language and has a difficulty level in the second language not exceeding the vocabulary level of the user in the second language.

21. The system of claim 17, wherein the processor is further configured to initiate an executable operation comprising:
computing the vocabulary level of the first user according to a difficulty level for words within a writing history of the first user.

22. The system of claim 17, wherein the processor is further configured to initiate an executable operation comprising:
computing the vocabulary level of the first user according to a difficulty level for words within a reading history for the first user.

23. The system of claim 17, wherein the processor is further configured to initiate an executable operation comprising:
computing the vocabulary level of the first user according to a difficulty level for words within documents of at least a second user having attributes matching attributes of the first user.

24. The system of claim 17, wherein the processor is further configured to initiate an executable operation comprising:
computing the vocabulary level of the first user according to a global vocabulary level of the first language.

25. A computer program product, comprising:
a computer readable storage medium having computer readable program code embodied therewith that, when executed, configures a processor to perform executable operations comprising:
calculating a vocabulary level for a user in a first language;
comparing difficulty levels of words within a document in the first language to the vocabulary level of the user in the first language; and
selecting each word of the document having a difficulty level that exceeds the vocabulary level of the user in the first language.

26. A computer program product, comprising:
a computer readable storage medium having computer readable program code embodied therewith that, when executed, configures a processor to perform executable operations comprising:
calculating a vocabulary level for a first user in a first language;
determining a difficulty level for each of a plurality of words within a document in the first language;
comparing the difficulty level of words in the document to the vocabulary level of the first user; and
selecting each word having a difficulty level that exceeds the vocabulary level of the first user for the first language.
